(19) United States
(12) Patent Application Publication
(10) Pub. No.: US 2007/0234087 A1
(43) Pub. Date: Oct. 4, 2007

(54) Method and apparatus for preventing over-current computer operation from limited power source

(75) Inventors: Daryl Carvis Cromer, Cary, NC (US); James Stephen Rutledge, Durham, NC (US); James C. Salembier, Cary, NC (US)

Correspondence Address: ROGITZ & ASSOCIATES, 750 B STREET, SUITE 3120, SAN DIEGO, CA, 92101, US

(73) Assignee: Lenovo (Singapore) Pte. Ltd.

(21) Appl. No.: 11/394,073

(22) Filed: Mar. 29, 2006

(51) Int. Cl. G06F 1/00

(52) U.S. Cl. 713/310

(57) ABSTRACT

A power adaptor for a computer is limited to draw no more power than would trip an aircraft circuit breaker.

### FIELD OF THE INVENTION

The present invention relates generally to methods and apparatus for preventing over-current computer operation from a limited power source.

### BACKGROUND OF THE INVENTION

Mobile computers can be used in various power environments, e.g., in a car, in an office, on an airplane, etc. Accordingly, computers come equipped with power adapters that can be plugged into sockets on the wall of an office, the bulkhead of an airplane, the cigarette lighter of a car, etc. to power the computers and thereby save battery life for times when no socket is available.

As understood herein, mobile computers can be comparatively power hungry, drawing from ninety to one hundred watts of power, with high power draws typically occurring when the computer is being simultaneously charged and used at high capacity. As understood herein, some power sources, particularly airplane power sources, do not permit more than seventy five watts of power to be drawn from any one socket; a circuit breaker trips when the limit is exceeded. This is inconvenient to the user and can lead to loss of data. With these critical recognitions in mind, the solution herein is provided.

### SUMMARY OF THE INVENTION

A system includes a computer and a power adapter connectable to the computer to supply power thereto. The adapter is configured to engage an outlet of a power supply such as an aircraft grid, and power drawn through the adaptor is limited to a predetermined power limit, e.g., to seventy five Watts. The predetermined power limit may be established by a user of the computer or by a computer vendor.

In some implementations the computer and/or adaptor determines a power consumption through the adaptor and compares it to the limit. If power consumption is below the limit, the computer is permitted to operate as it is operating, and otherwise computer operation is automatically altered to ensure that the limit is not exceeded. Computer operation may be automatically altered by switching to a low power mode and/or by curtailing battery charging.

In another aspect, a method includes using an adapter to convert power from a source into a demanded dc power to power a computer, and limiting power drawn through the adaptor to be below an aircraft circuit breaker trip point.

In yet another aspect, a system includes an adapter with means for converting ac power to dc power for use thereof by a computer, and means for limiting power drawn through the adaptor to be below an aircraft circuit breaker trip point.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system; and

FIG. 2 is a flow chart showing the logic of the present invention.

### DETAILED DESCRIPTION OF THE PREFERRED EMBODIMENT

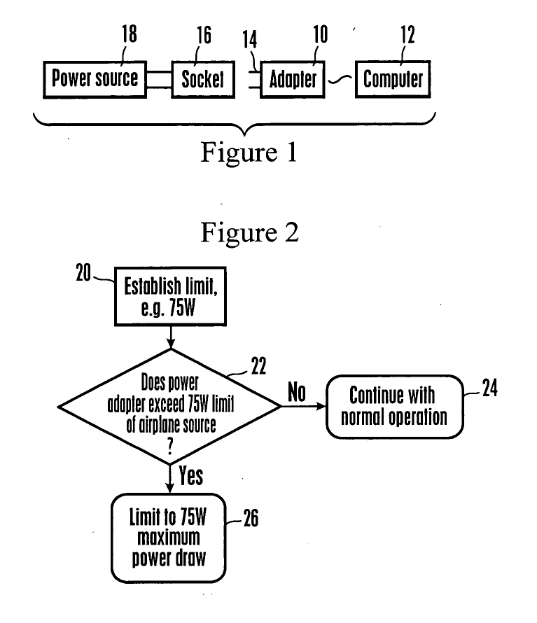

Referring initially to FIG. 1, a power adapter 10 is shown that is electrically connectable to a computer 12 such as but not limited to a laptop computer or notebook computer or personal digital assistant for supplying the computer 12 with power. More particularly, the adapter 10 may include one, two, three or more prongs 14 that are configured to engage respective receptacles in a socket 16, and the socket 16 is electrically connected to a power source 18 such as an airplane power grid, so that the adapter 10 converts the voltage from the power source 18 to a voltage as required by the computer 12.

FIG. 2 shows the present logic. Commencing at block 20, a desired power limit is established by the user of the computer or in the computer vendor's facility. The power limit preferably is seventy five Watts, since that is the breaker trip point for typical passenger airplane sockets, although other wattages can be used as, e.g., breaker trip points might increase.

Once the power limit has been set at, e.g., the vendor facility and the computer purchased by the user for portable use, the remaining logic in FIG. 2 can be executed by a processor within the adaptor 10 or within the computer 12. Assuming the adaptor 10 has been plugged into a socket 16 of an airplane and the computer 12 is in use and connected to the adaptor 10, at decision diamond 22 it is determined whether the power consumption through the adaptor 10 (as measured by, e.g., current) exceeds the limit established at block 20. If power consumption is below the limit the computer is permitted to operate it currently is operating at state 24. Otherwise, i.e., when the power draw approaches the limit, at state 26 computer operation is automatically altered to ensure that the limit is not exceeded.

In one non-limiting implementation the computer can be switched to a low power mode at state 26, where certain tasks or applications are not conducted or are abbreviated. Alternatively, computer applications might not be limited but battery charging can be curtailed or eliminated.

It is to be understood that while FIG. 2 is in flow chart format, the present logic may be implemented as state logic, wherein block 26 is executed whenever power draw through the adaptor 10 is sensed to approach and/or exceed the power limit of, e.g., 75 W.

While the particular METHOD AND APPARATUS FOR INFORMING COMPUTER OF POWER ENVIRONMENT is herein shown and described in detail, it is to be understood that the subject matter encompassed by the present invention is limited only by the claims.

What is claimed is:

1. A system, comprising:
a computer; and
at least one power adapter connectable to the computer to supply power thereto, the adapter being configured to engage an outlet of a power supply, power drawn through the adaptor being limited to a predetermined power limit.

2. The system of claim 1, wherein the predetermined power limit is established by a user of the computer or by a computer vendor.

3. The system of claim 1, wherein the power limit is seventy five Watts.

4. The system of claim 3, wherein the computer and/or adaptor determines a power consumption through the adaptor and compares it to the limit.

5. The system of claim 4, wherein if power consumption is below the limit, the computer is permitted to operate as it is operating, and otherwise computer operation is automatically altered to ensure that the limit is not exceeded.

6. The system of claim 5, wherein computer operation is automatically altered by switching to a low power mode.

7. The system of claim 5, wherein computer operation is automatically altered by curtailing battery charging.

8. A method, comprising:
providing an adapter to convert power from a source into a demanded dc power to power a computer;
determining an aircraft circuit breaker trip point; and
limiting power drawn through the adaptor to be below the aircraft circuit breaker trip point.

9. The method of claim 8, wherein the trip point is seventy five Watts.

10. The method of claim 8, wherein if power consumption is below a predetermined limit, the computer is permitted to operate as it is operating, and otherwise computer operation is automatically altered to ensure that the limit is not exceeded.

11. The method of claim 10, wherein computer operation is automatically altered by switching to a low power mode.

12. The method of claim 10, wherein computer operation is automatically altered by curtailing battery charging.

13. A system, comprising:
an adapter including:
means for converting ac power to dc power for use thereof by a computer; and
means for limiting power drawn through the adaptor to be below a predetermined aircraft circuit breaker trip point.

14. The system of claim 13, wherein the means for limiting limits power drawn through the adaptor to be below seventy five Watts.

15. The system of claim 14, wherein if power consumption is below seventy five watts, the computer is permitted to operate as it is operating, and otherwise computer operation is automatically altered.

16. The system of claim 15, wherein computer operation is automatically altered by switching to a low power mode.

17. The system of claim 15, wherein computer operation is automatically altered by curtailing battery charging.
